(19) United States
(12) Patent Application Publication
(10) Pub. No.: US 2024/0354124 A1
(43) Pub. Date: Oct. 24, 2024

(54) INTERFACE METHODS FOR IDENTIFYING WEATHER CONDITIONS WITHIN VIEW OF A USER DEVICE

(71) Applicant: THE WEATHER COMPANY, LLC, Brookhaven, GA (US)

(72) Inventors: Robert N. Redmond, Smyrna, GA (US); Jordan Fripp, Roswell, GA (US); Arjun Rajendra Gandhi, Atlanta, GA (US); Sarah Lynn Hardison, Durham, NC (US); Scott McCall, Durham, NC (US)

(21) Appl. No.: 18/138,613

(22) Filed: Apr. 24, 2023

(51) Int. Cl. G06F 9/451; H04W 4/02

(52) U.S. Cl. CPC G06F 9/451; H04W 4/026

(57) ABSTRACT

A computer-implemented method, in accordance with one embodiment, includes receiving a set of weather data corresponding to a region, the set of weather data indicating current and/or future weather conditions based on time. A location and an orientation of a device of a user are determined. An augmented view of weather conditions at a particular point in time is rendered on the device, based on the set of weather data and the determined location and orientation of the device. Rendered elements in the augmented view are updated based on a change in device location, a change in the orientation of the device, and/or a change in the weather data over time.

### BACKGROUND

The present invention relates to outputting weather conditions, and more specifically, this invention relates to outputting an indication of weather conditions within view of a device, such as a mobile device of a user.

Many people rely on weather data and information to help them plan and make decisions about their daily activities such as their commute, leisure activities as well as prepare and shelter when weather conditions turn hazardous.

Commonly available information to aid in these decisions comes from systems such as a news station that provides forecasted information with the support of an on air meteorologist and a series of fairly standardized visual models that may include doppler radar, a map, grids, and charts suggesting the passage of time or intensity of oncoming weather phenomena. Other commonly used tools are websites and mobile apps that convey weather information in 2-dimensional (2D) and 3-dimensional (3D) format, but are typically limited to an interface that is customized by the designer of the app and only provides general information about the location (e.g., latitude and longitude) of the device as provided by a location service of the device, e.g., via Global Positioning Service (GPS) or other location based mechanism.

### SUMMARY

A computer-implemented method, in accordance with one embodiment, includes receiving a set of weather data corresponding to a region, the set of weather data indicating current and/or future weather conditions based on time. A location and an orientation of a device of a user are determined. An augmented view of weather conditions at a particular point in time is rendered on the device, based on the set of weather data and the determined location and orientation of the device. Rendered elements in the augmented view are updated based on a change in device location, a change in the orientation of the device, and/or a change in the weather data over time.

A computer program product, in accordance with one embodiment, includes one or more computer readable storage media, and program instructions collectively stored on the one or more computer readable storage media. The program instructions include program instructions to perform the foregoing method.

A system, in accordance with one embodiment, includes a processor and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 depicts an exemplary embodiment of a system for rendering interface elements supporting both real time observations and forecast observations, in accordance with one embodiment of the present invention.

FIG. 4 is a depiction of a user's perspective when viewing an exemplary output of the camera's view on a display screen of a device, along with surroundings in the portion of the user's field of view not blocked by the device, in accordance with one embodiment of the present invention.

FIG. 5 illustrates a rendering of weather conditions-related tokens and graphics on the device of FIG. 4, in accordance with one embodiment of the present invention.

FIG. 6 illustrates an exemplary rendering of tokens and graphics for weather in a current field of view, in accordance with one embodiment of the present invention.

FIG. 7 illustrates an update of the rendering of FIG. 6 to show a new token providing details about a lightning strike, in accordance with one embodiment of the present invention.

FIG. 8 illustrates an update of the rendering of FIG. 5 with a virtual representation of conditions in the area at the selected time, in accordance with one embodiment of the present invention.

FIG. 9 illustrates a rendering with graphics and tokens indicative of pollen levels in the environment of the device, in accordance with one embodiment of the present invention.

FIG. 10 illustrates an update of the rendering of FIG. 9, in accordance with one embodiment of the present invention.

FIG. 11 illustrates a rendering with graphics and tokens indicative of a UV level in the environment of the device, in accordance with one embodiment of the present invention.

FIG. 12 depicts modification of the rendering of FIG. 11 to include graphics and tokens representing different positions of the sun at the noted times, along with the UV index at that time, in accordance with one embodiment of the present invention.

FIG. 13 depicts modification of the rendering of FIG. 12 upon detecting selection of one of the tokens, in accordance with one embodiment of the present invention.

FIG. 14 depicts a rendering with graphics and tokens indicative of wind occurring in the environment of the device, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for outputting an indication of weather conditions within view of a device, such as via augmented reality on a mobile device of a user, thereby providing an enhanced understanding of actual weather within the device's view, and thus within the user's view if the user is with the device.

In one general embodiment, a computer-implemented method includes receiving a set of weather data corresponding to a region, the set of weather data indicating current and/or future weather conditions based on time. A location and an orientation of a device of a user are determined. An augmented view of weather conditions at a particular point in time is rendered on the device, based on the set of weather data and the determined location and orientation of the device. Rendered elements in the augmented view are updated based on a change in device location, a change in orientation of the device, and/or a change in the weather data over time.

In another general embodiment, a computer program product includes one or more computer readable storage media, and program instructions collectively stored on the one or more computer readable storage media. The program instructions include program instructions to perform the foregoing method.

In another general embodiment, a system includes a processor and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for outputting an indication of weather conditions within view of a device in block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

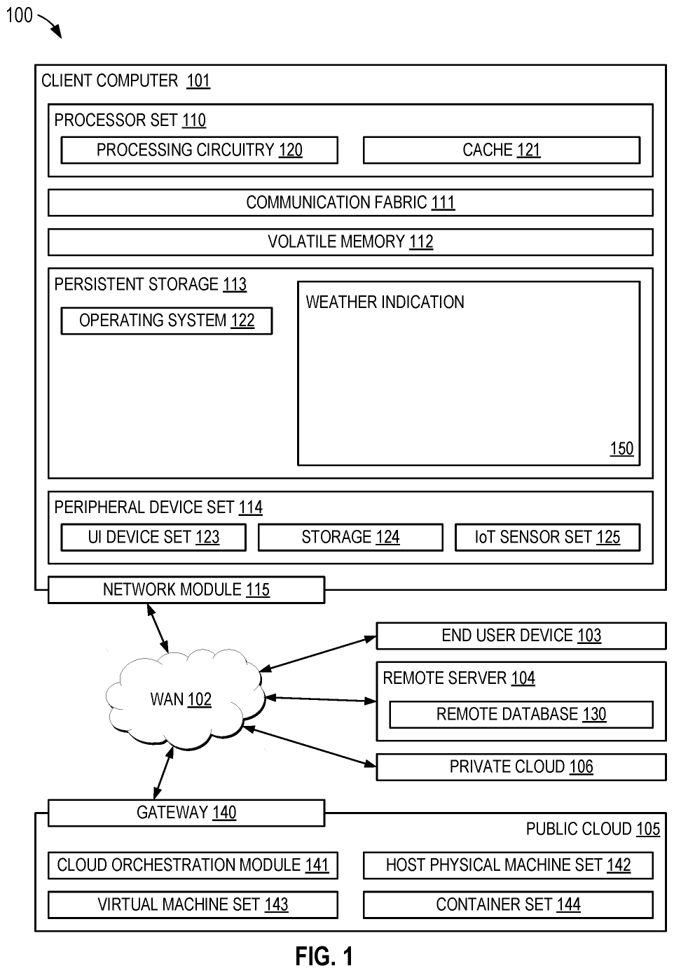

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As noted above, existing forms of weather services include news stations, websites, and mobile apps. While these traditional approaches have been the observed norm for decades, they all fail to fully equip the individual user with a strong understanding of the conditions they are being provided information about, and more often than not, fail to adequately communicate immediate weather impacts, based on the viewer's current experience of the world.

As an example, though radar laid over a map has largely become commonplace across all methods of communicating weather conditions, the average user viewing a radar rendition purporting to cover their general vicinity is unable to determine the direction of travel of the conditions they are observing from their actual current location.

These observational issues are especially important when a user is out and about, especially when conditions are changing swiftly. The ability of the user to take appropriate action can be hindered by a lack of situational awareness of their surroundings and the direction of the oncoming conditions.

Described herein, according to some embodiments, is an interface-driven method to render and display user-relevant weather phenomena conditions onto a display screen using augmented reality and real-time weather condition data relevant to the current location of a device, which is typically the location of the user, along with the current viewing direction. Such a device may be any type of device, such as a hand-held mobile device (e.g., mobile telephone, tablet, etc.), electronic glasses (e.g., augmented reality (AR) glasses, virtual reality (VR) glasses, etc.), laptop computer, etc. The device may be of conventional construction, but modified to include the new features described herein, e.g., via installation/updating of an application, software, firmware, etc. on the device.

In one example of use, as a user points the device in any direction, an interface is presented, via the display screen of the device, onto the user's view with relevant observed weather conditions represented within the field of view of the user, in a way that is relevant to the current perspective of the device, and thus the current perspective of the user. Any type of weather condition may be represented on the display of the device, including any weather condition that would become apparent to one skilled in the art after reading the present disclosure. Examples of conditions that may be projected include but are not limited to: precipitation, precipitation intensity, direction of wind, direction of movement of a storm front, distance to precipitation in the augmented view, lightning strikes as said strikes occur, and depth of precipitation accumulation.

As described in more detail below, in preferred embodiments, these interface elements have the capacity to report real-time information as it happens, as well as the ability to transform into forecasted information as the user selects a future time, e.g., by moving a timeline widget forward, to observe conditions that are currently predicted to impact the user in the near future.

Conditions that are predicted in the future may be rendered into the user's view via the display screen utilizing a particle system and forecasted weather data.

As also described in more detail below, the interface adapts both to the changing conditions and circumstances of the weather the user is experiencing while also adjusting for the view that the user is taking in and their potential to change or shift location relative to the oncoming weather conditions, via determining directionality of the device.

Accordingly, various embodiments provide a situational awareness for the user based on the current location of the user's device, and based on the user's view of the oncoming weather phenomena based on directionality of the device, and provides additional tools to preview what type of weather event is coming based on the user's surroundings, thereby transforming the user's understanding of the information and further empowering their ability to react to it.

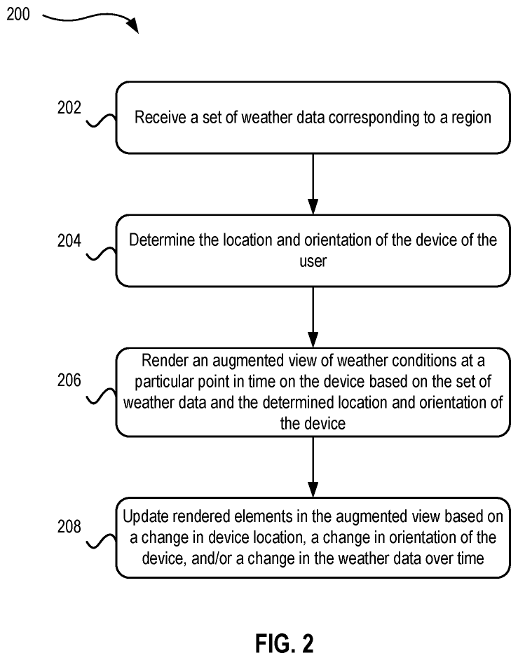

Now referring to FIG. 2, a flowchart of a method 200 is shown according to one embodiment. The method 200 may be performed in accordance with the present invention in any of the environments depicted in FIG. 1 and other FIGS. described herein, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a mobile device, electronic glasses, or some other device having one or more processors therein and/or coupled thereto. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 2, method 200 may initiate with operation 202, where a set of weather data corresponding to a region is received. The set of weather data indicates current and/or future weather conditions based on time. For example, the set of weather data may include current weather conditions for the current time. In another example, the weather data may include predicted weather conditions for a future time, or a range of times.

Preferably, the weather data corresponds to the current location of the user's device. Accordingly, the set of weather data may be received by the user device in response to the device requesting the weather data and providing the location of the device to the source of the weather data along with the request.

In operation 204, a determination is made as to the location and orientation of the device of the user.

As noted above, the location may have been found prior to sending a request for the set of weather data. In other approaches, the location of the device is determined, for the first time or anew, after the weather data is received. In yet other approaches, a more accurate location is determined, preferably a location accurate to within a few feet of the device's actual position. For example, the accuracy provided by a standard GPS system is more accurate than a location determined based on connectivity to cellular telephone towers for example.

The orientation of the device may be determined by any manner of techniques. In one approach, sensors within the device are used, such as a gyroscope, a compass, etc. In another approach, an orientation is determined based on an analysis of an image captured by a camera of the device. In a further approach, the orientation is determined based on both the image data from the camera and data from sensors.

In operation 206, an augmented view of weather conditions at a particular point in time is rendered on the device based on the set of weather data and the determined location and orientation of the device. In a preferred approach, the determined location and orientation of the device are used to extract weather conditions from the set of weather data that are located in front of the device, and representations of the weather conditions are output on the display of the device. The representations are preferably overlaid over an image or video of the actual scene in front of the device, as provided by a front facing camera of the device.

In some approaches, the weather data is received from a spatial weather translation system, e.g., as described in more detail below in conjunction with an exemplary embodiment. Weather data and observed weather phenomena are transformed from various sources such as 2D plotting and/or radar data to data elements that are consumable by an interface system that performs the rendering on the device of the user.

An example of the rendering of operation 206, in accordance with an exemplary embodiment, is also provided below.

The augmented view of weather conditions may include a set of tokens indicating characteristics of the weather conditions. The set may include one or more tokens. All tokens in the set may be the same, or there may be a variety of different tokens.

The tokens may be words, icons, windows, or anything else that indicates a characteristic of a weather condition. Tokens may include details about the observation, for example: type, distance, danger, time to impact, etc. Examples of tokens are presented immediately below, as well as in the exemplary embodiment below.

In one approach, the set of tokens includes a token corresponding to a type of weather condition, such as rain, snow, sleet, hail, sunshine, etc. The token may include a word representing the weather condition, and image or character representing the weather condition, etc.

In one approach, the set of tokens includes a token corresponding to a distance of a weather condition, e.g., from the location of the device. For example, such a token may note the estimated distance, preferably numerically and with units of measurement; may indicate the type of weather condition, e.g., lightning strike; etc.

In one approach, the set of tokens includes a token corresponding to a time of impact of a weather condition, e.g., into the field of view of the camera, onto the location of the device, etc. For example, the token may include a notation in units of time representing the time until the weather condition impacts the particular location, such as a depiction of a storm cloud with a number of minutes until the storm cloud reaches the location of the device.

In one approach, the set of tokens includes a token corresponding to a severity of a weather condition. For example, the token may include a color or icon depicting how strong a rain fall is expected to be, how strong wind is expected to be, etc.

In preferred approaches, some of the tokens may include multiple types of information in a single token, such as type of weather condition, direction of movement of the weather condition, and an indication of the severity of the weather condition.

In operation 208, rendered elements in the augmented view are updated based on a change in device location, a change in orientation of the device, and/or a change in the weather data over time. The updating may be performed periodically, continually, in response to detecting one of these changes, etc. For example, pivoting the device to the right may result in rendered elements at or predicted to be to the right of the previous field of view now being shown on top of the new field of view.

As alluded to above, the rendered weather conditions correspond to a particular point in time, whether that is a current time, a future time, or both. The point in time may be a default time, such as a current time. However, it is preferable that the particular point in time is selectable by the user of the device. For example, the device may receive selection of a “now” button or the like, instructing the rendering system to render an augmented view of current conditions.

In particularly preferred embodiments, a way to allow the user to select a future time is presented. In one approach, a time-selection user interface element is presented on the display of the device for allowing the user to select a time for which corresponding weather conditions will be displayed. A selection of a particular time to display weather conditions is received from the user via the time-selection user interface element. In response to receiving the selection, a second augmented view of weather conditions corresponding to the selection of the particular time by the user is rendered. Note also that the forecasted weather data is preferably updated based on the transition of space and time from the original engagement, according to the selected time.

### Exemplary Embodiment

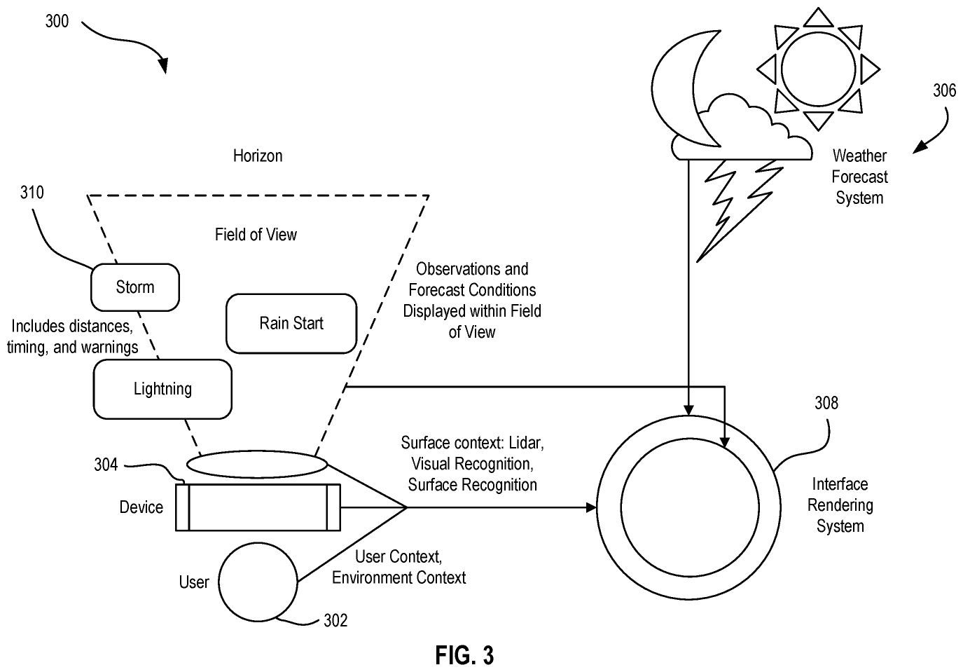

FIG. 3 depicts an exemplary embodiment of a system 300 for rendering interface elements supporting both real time observations and forecast observations, in accordance with one embodiment. Peripheral items and conditions are also shown, such as a user, the field of view, etc. As an option, the present system 300 may be implemented in conjunction with features from any other embodiment listed herein, such as those described with reference to the other FIGS. Of course, however, such system 300 and others presented herein may be used in various applications and/or in permutations which may or may not be specifically described in the illustrative embodiments listed herein. Further, the system 300 presented herein may be used in any desired environment.

As shown, a user 302 launches an application on a device 304 that provides a view of the user's surrounding area, as captured by a camera of the device. Again, such device 304 may be a mobile device, AR glasses, etc.

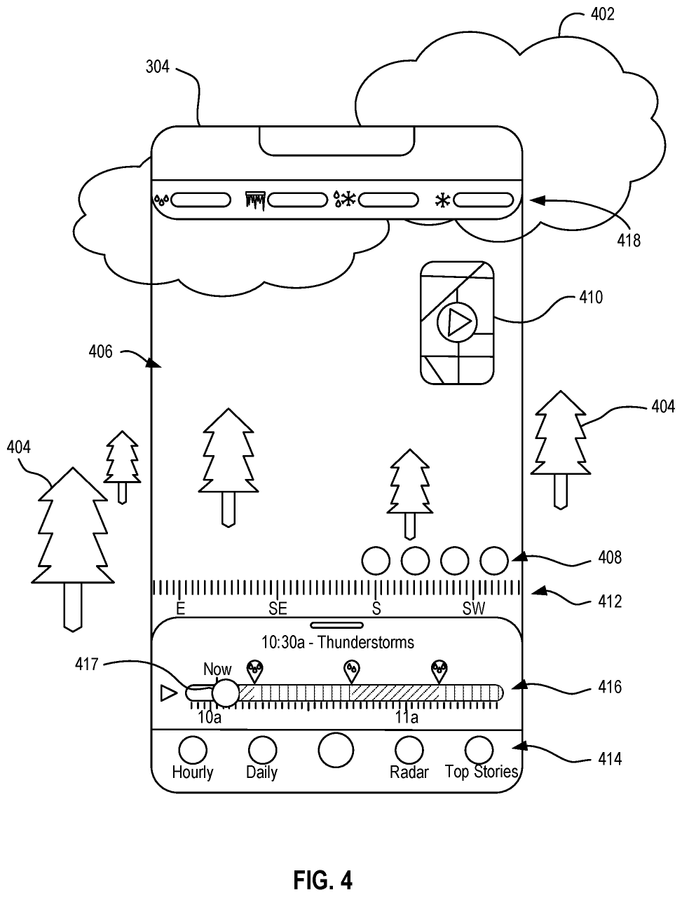

FIG. 4 illustrates a user's perspective when viewing an exemplary output of the camera's view on a display screen of the device 304, along with surroundings, e.g., clouds 402 and trees 404, in the portion of the user's field of view not blocked by the device 304. As shown, the image 406 rendered on the display screen depicts the portion of the user's view blocked by the device. Other features may also be presented on the screen, including function buttons 408, which provide some function such as toggling layers, capturing a screenshot of the rendering, taking a picture using the camera, selecting a particular function such as display of an ultraviolet (UV) index, etc. A miniature map 410 may be provided to show a general location of the device, a rendering of radar weather data, etc. Compass information 412 may be provided to show the direction the device is pointing. Additional weather related buttons 414 are presented along the bottom of the display. A timeline 416 indicating weather changes, here an intensity of rain for the next hour and a half, is shown, along with a toggle 417 that allows selection of a future time, for reasons that will soon become apparent. Moreover, a legend 418 for intensities of rain, ice, sleet and snow is provided, e.g., via icons and an oval color panel that represents increasing intensity with changing color. The color may be applied to the tokens to visually indicate an intensity of the weather condition represented in the token.

A spatial weather translation system 306 provides data to an interface rendering system 308. The interface rendering system 308 preferably runs on device 304, but in some approaches may operate remotely, e.g., in a cloud.

The spatial weather translation system 306 transforms weather data and observed weather phenomena from various sources such as 2D plotting, point-based weather reporting, and/or radar data to data elements that are consumable by the interface rendering system 308, preferably in a manner that allows the interface rendering system 308 to project information corresponding to the actual weather conditions noted in the weather data and observed weather phenomena. The 2D plotting data, reporting data, and/or radar data may be obtained from any suitable source or set of sources, such as a weather database, a website, a collection of reported weather phenomena, weather readings received in real time, etc. For example, the spatial weather translation system 306 may combine and transmit information gathered from 2D and point-based weather-reporting and forecasting systems into a 3-dimensionally aware system for the distribution of information in a spatially and temporally relative manner. The spatial weather translation system 306 collects both the current and progressive movement of weather phenomena as plotted on, for example, a weather/Doppler radar system alongside the shifting intensity and impact of observed weather phenomena and translates them into a spatial construct providing markers that define constraints of phenomena (front and back of a storm system, height of a storm system, wind currents and shifts, rainfall intensity, etc., as examples) across both the currently observed environment as well as the forecasted shifts over time. In addition, the spatial weather translation system 306 preferably has the ability to transmorph the boundaries of the weather event(s) within the temporal construct as actual observed data is updated.

These spatially translated markers may provide a definition of at least some of the occurring weather phenomena across a pre-specified geographic area, and can be utilized within an augmented reality (or equivalently, merged reality) environment to label, display, and/or measure distance and time between events. The markers may be combined with a specific lat-long coordinate to determine the impact of weather phenomena on the proposed location both in current and future views. This spatial translation in turn aids in the translation of weather phenomena into a 3D construct that can be consumed, for example, by a situationally aware visual representation of weather phenomena across the field of view of a user.

### Real Time Observation by Exemplary Embodiment

The interface rendering system 308 extracts the current location of the device, as well as other relevant positional information such as elevation and orientation, and models the distance between the device 304 and the weather phenomena to be positioned within the interface via tokens 310 and graphics to illustrate weather phenomena.

As noted above, the interface rendering system 308 uses user interface (UI) elements to convey situational awareness at a deeper level than has heretofore been possible. One type of UI elements involves the use of weather “tokens” 310 which denote details about a weather condition, such as the type, distance, trajectory, danger, time to impact, and time of arrival of surrounding weather systems, such as different forms of precipitation.

Additional types of UI elements generated by interface rendering system 308 are graphics illustrating weather characteristics such as the direction of a storm; the trajectory of the storm; visualization of non-observable things such as UV index, pollen and smog; etc.

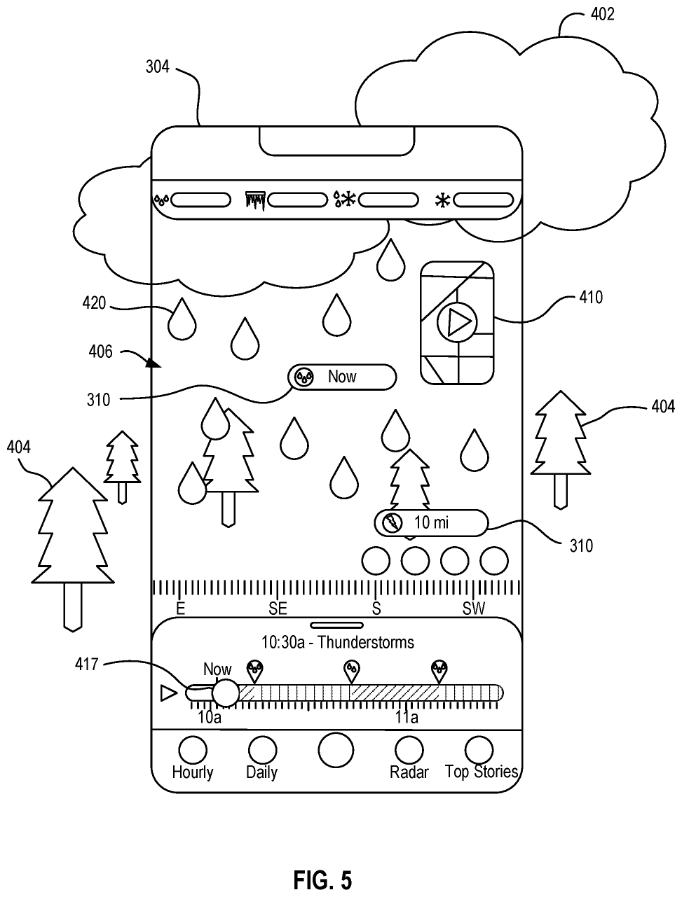

FIG. 5 illustrates the rendering on device 304 shown in FIG. 4 when tokens 310 and graphics 420 are added. As shown, one token 310 includes a depiction of raindrops and notes that the rain is present in the view “now.” Another token 310 depicts a lightning bolt and has the caption “10 mi” to indicate that a lightning strike occurred 10 miles away. The graphics 420 include raindrops superimposed over the image/video from the camera. The interface rendering system 308 analyzes the received weather data and renders it onto the visual space, for example, positioning a storm front where it is, where the rain is going to start, where the rain is going to end, how heavy the rain is and/or will be, etc.

Referring again to FIG. 3, to determine which token and graphic to place where, the interface rendering system 308 processes geo-spatial data (e.g., lat./long. coordinates, direction of view, etc.), gyroscopic inputs (to detect alteration in view in real-time) and then translates these datums into the plotting of weather phenomena to the visual display.

The tokens shown in FIG. 5 are plotted based on the current observed conditions at the moment the user engaged.

In addition, tokens may contain forecast data about the specific phenomena they represent, thereby allowing the user to not just understand the conditions the user is experiencing, but how such conditions will evolve over time, both in proximity to the individual and based on the trajectory of the constantly evolving real weather scenario playing out in their area.

In a preferred approach, the interface rendering system 308 instantiates the user interface placing all of the currently observed weather conditions within the camera's field of view, denoting distance and time since recorded observance. The interface rendering system 308 continues to update conditions as new information is made available by the spatial weather translation system 306. The interface rendering system 308 also updates the position of the denoted conditions in response to detecting a shift in view of the camera, e.g., because the user is moving the device around, in transit (e.g., walking or on a train), turning to look in a different direction, etc. Preferably, the interface rendering system 308 maintains interface element positioning in augmented space based on the user's view relative to the observations defined (lat-long) position in space.

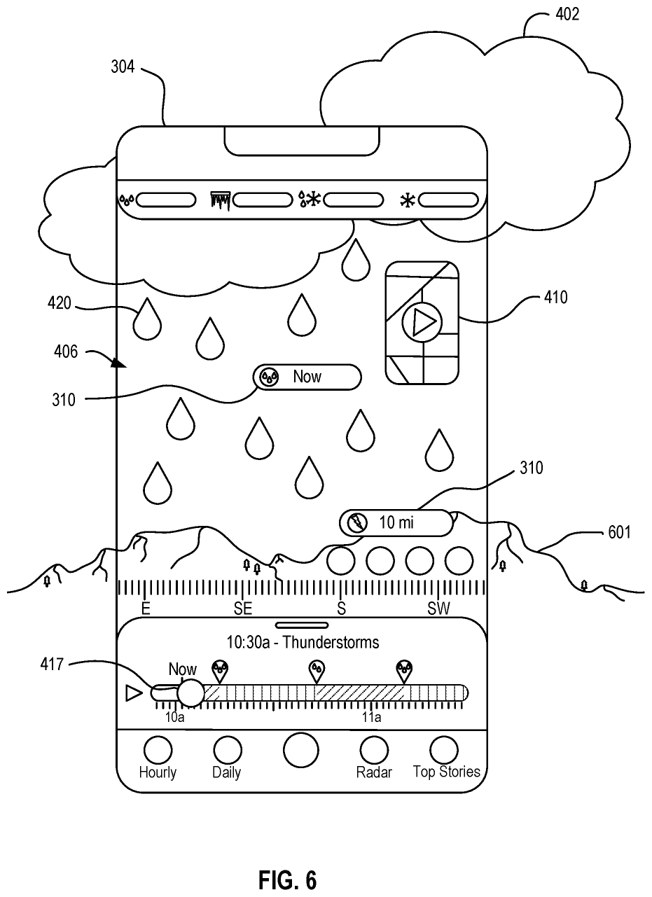

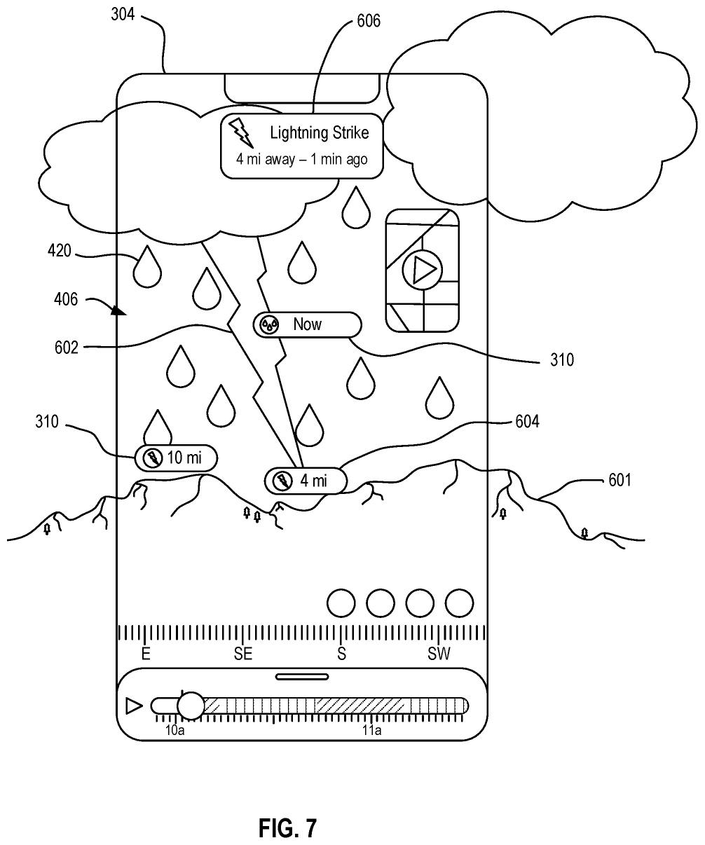

For example, FIG. 6 illustrates an exemplary rendering of tokens 310 and graphics 420 for weather in a current field of view with a mountain 601 in said view. Upon occurrence of a lightning strike 602 within the field of view, the rendering may be updated as shown in FIG. 7 to show a new token 604 providing details about the lightning strike, here a token placed at an approximate position of the lighting strike, and having a lightning bolt icon identifying the token as relating to a lightning strike and its distance (4 mi) from the device. Another token 606 is also shown with more details, including a textual identification of the event (“Lightning Strike”), the distance (“4 mi away”), and an elapsed time since the event (“1 min ago”). In this example, the second token 606 is presented at the top of the display, and the color coded intensity legend is removed to make room for the token 606. Thus, as should now be apparent to those skilled in the art, the rendering may be dynamically output in many ways to provide a plethora of information to the user.

Preferably, weather data is continuously, periodically, sporadically, etc. received, and the interface rendering system 308 preferably updates the rendering in real time as such weather data is received. For example, if a storm is approaching, the tokens and/or graphics are preferably updated as new weather data is received. The token indicating the time until the storm reaches the location of the device can be updated for instance.

### Forecast Observation by Exemplary Embodiment

A user may be interested in understanding the conditions that are forecast to enter their area. Forecasted weather data may be received from any known source, e.g., that provides a weather forecast for a relevant geographical area. Referring again to FIG. 5, a toggle 417 such as a timeline slider may be provided to allow the user to progress forward through the predicted conditions that will impact the immediate area.

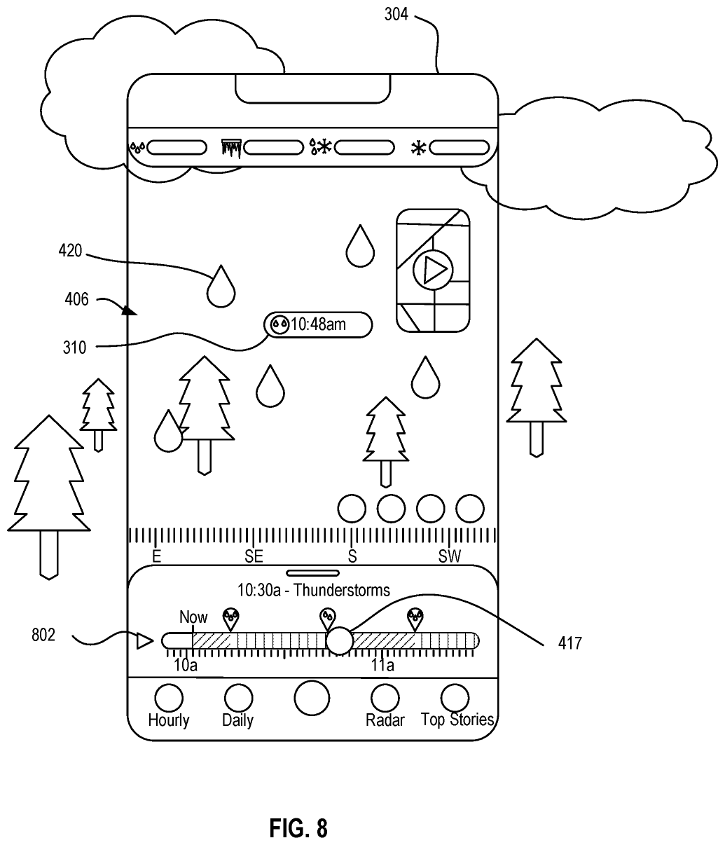

As shown in FIG. 8, the interface rendering system augments the rendering of FIG. 5 with a virtual representation of conditions in the area at the selected time. In the example shown, the rainfall is predicted to be less, so fewer raindrop graphics are provided in the rendering. Moreover, the token shown in the center of the rendering lists the selected future time, and includes a depiction of two raindrops, rather than the three raindrops reflective of the rainier conditions occurring at the present time.

Some embodiments also provide a sequence or an animation showing the change in weather over time by changing the graphics and tokens to reflect weather conditions at different times. In one approach, sliding the slider toggle 417 causes the rendering to change according to the position of the slider toggle 417. As also shown in FIG. 8, a play button 802 may cause the slider to automatically move along the timeline. For example, if a rainstorm is forecast, the system will render the rainstorm approaching and building within the individual's field of view. This augmented representation of forecast conditions will also be useful for individuals who are attempting to view these conditions while inside, allowing them to project the actual and forecast conditions within a mixed reality environment.

Additional types of tokens may call out and provide visualization for different atmospheric conditions such as UV and pollen levels, even though such conditions are generally not visible to the human eye.

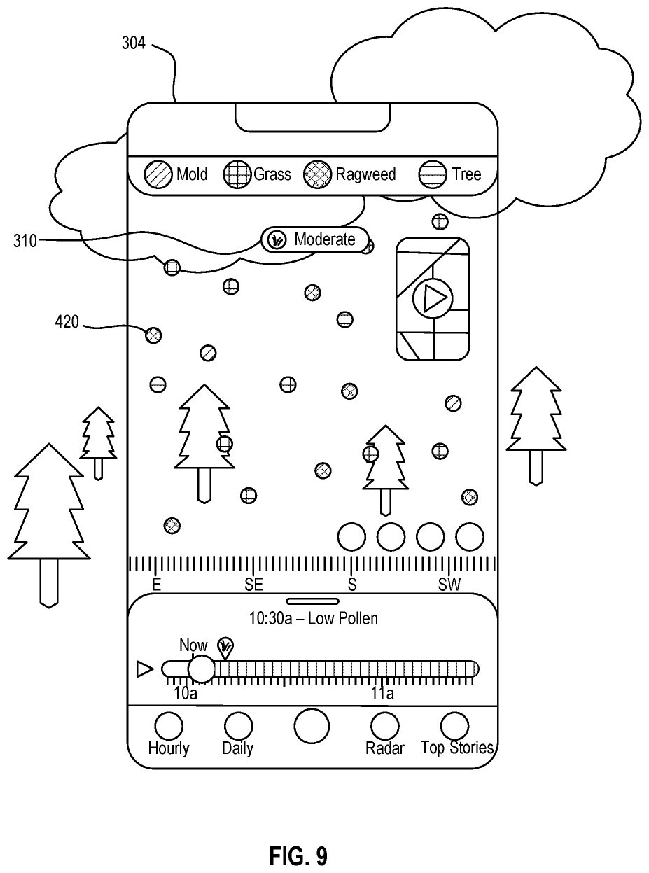

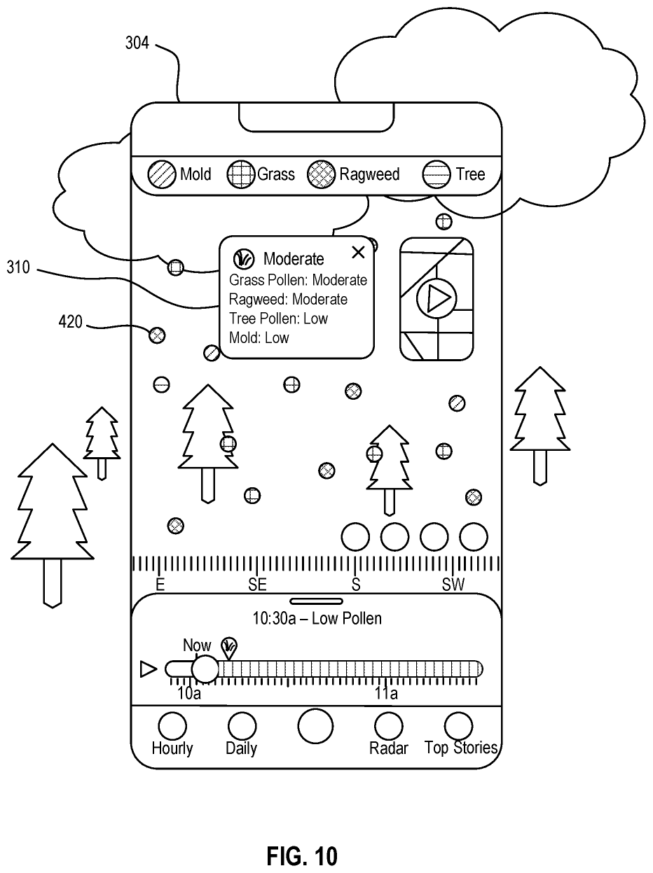

FIG. 9 illustrates a rendering with graphics 420 and tokens 310 indicative of pollen levels in the environment of the device 304. Other pollen-related information may be provided in the rendering, such as a legend for corelating different types of pollen to the graphics; an intensity indicator for the pollen e.g., via color; etc. UI tools and buttons similar to those present in other embodiments described herein may also be provided, such as a timeline toggle. FIG. 10 also demonstrates that tokens 310 in this and other embodiments may be interactive, e.g., selection of the token 310 at the center top of FIG. 9 by touching the token may cause the token to expand to display more information about the weather condition, or in this example, the current pollen-related atmospheric condition.

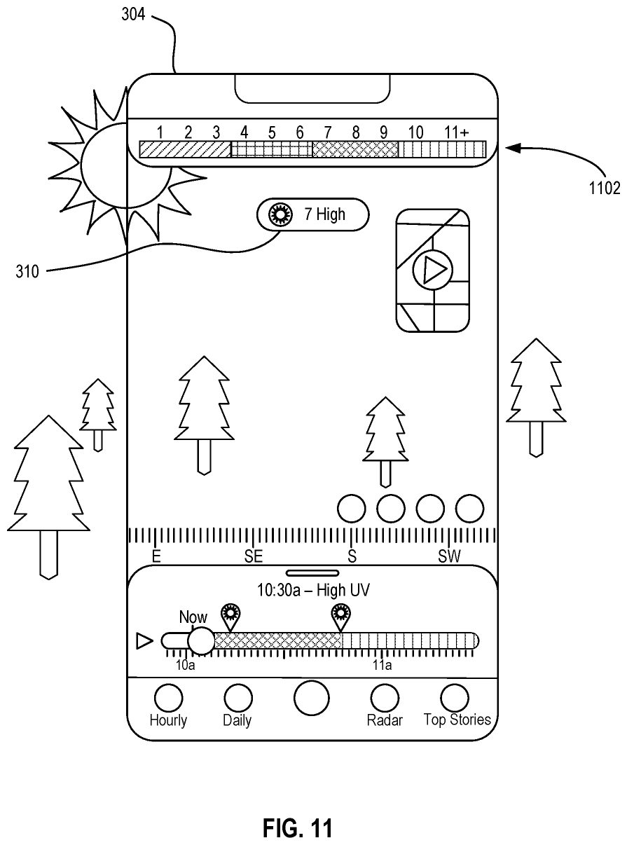

FIG. 11 illustrates a rendering with a token 310 indicative of a UV level in the environment of the device 304. Other UV-related information may be provided in the rendering, such as an intensity indicator 1102 that correlates a color of an icon in the token 310 to a UV intensity, etc. UI tools and buttons similar to those present in other embodiments described herein may also be provided.

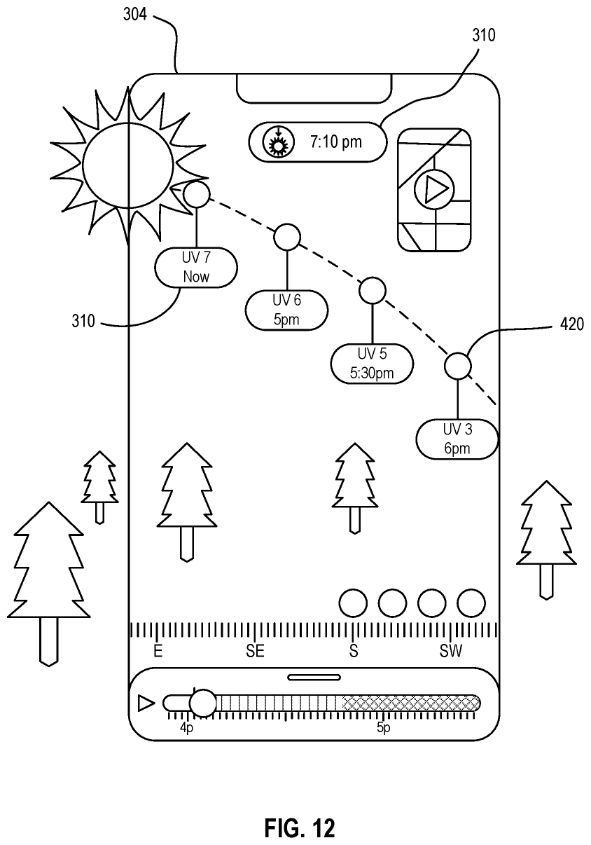

FIG. 12 depicts modification of the rendering of FIG. 11 to include graphics 420 representing different positions of the sun at the noted times, along with the UV index at that time via tokens 310. This information in turn allows a user to better plan their day, e.g., by leveraging the knowledge of where the sun will be in the sky at a given time and the resulting UV index, the user can adjust their plans accordingly.

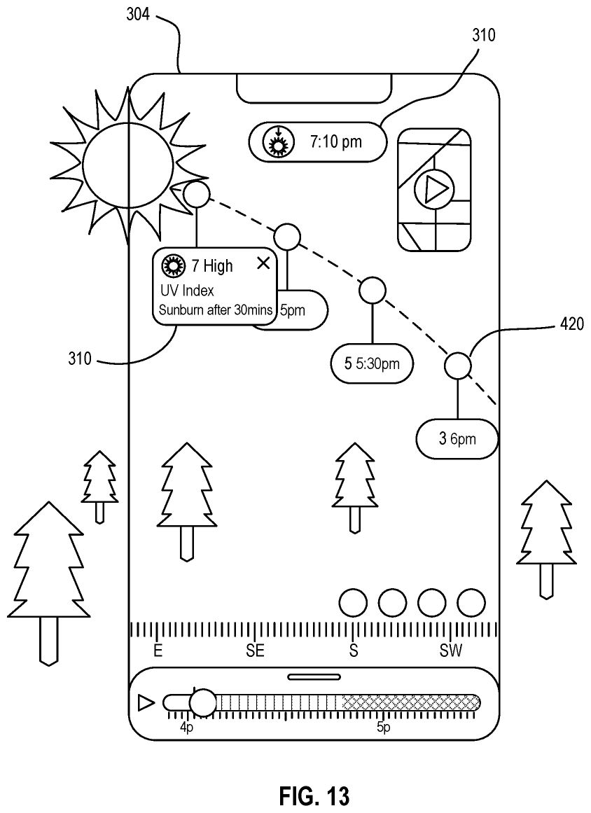

Upon detecting selection of one of the tokens 310, more information about the UV index at that time may be provided, as shown in FIG. 13.

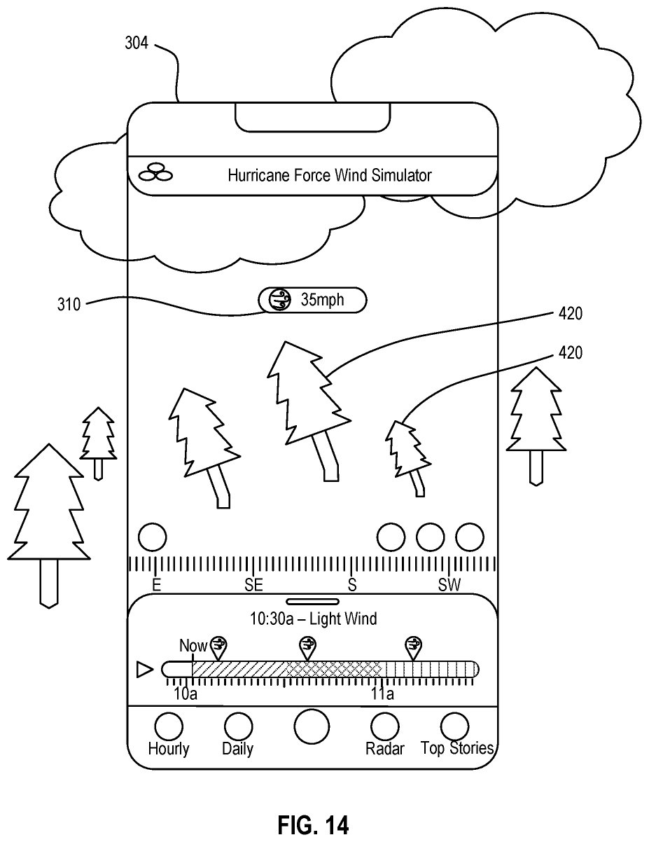

FIG. 14 depicts a rendering with graphics 420 and tokens 310 indicative of wind occurring in the environment of the device 304, e.g., by presenting graphics of trees appearing to bend in the wind. Other information may be provided in the rendering, such as an intensity indicator, etc. UI tools and buttons similar to those present in other embodiments described herein may also be provided.

There have thus been described various embodiments that use situational awareness to render real-time weather in contextual relevance to a user's position in space and time, as well as update the rendering and/or the weather phenomena being observed as both of those contexts are transformed by the user, e.g., the user moves the device.

Various embodiments presented herein provide enhanced situational awareness based on the device's current location and current and future weather conditions. For example, various embodiments are also useful for safety applications, by providing the ability to track the transformation of weather data over time, alongside the potential impact of the weather on the user's travel through both space and time. Moreover, the insights provided by the tokens and graphics help the user to better understand what impact the weather being observed is going to have on the user, thereby allowing the user to formulate a better plan going forward. Additionally, the insights provided are useful for maintaining safety, e.g., the user may stay in or find shelter when conditions are hazardous or will become hazardous.

Various embodiments presented herein provide enhanced situational awareness using understanding of the device's current view and where the weather is potentially coming from and/or where the weather is going, e.g., by updating the rendering based on both changes in device position and/or orientation as well as potential changes in the weather conditions, e.g., the wind shifts and pushes the storm toward the user instead of the previously-predicted path that would have missed the user. Moreover, rendered future views provide the user with a real-time understanding of what type of weather condition is to come and how it will enter into their area.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a set of weather data corresponding to a region, the set of weather data indicating current and/or future weather conditions based on time;
determining a location and an orientation of a device of a user; and
rendering, on the device of the user, an augmented view of weather conditions at a particular point in time based on the set of weather data and the determined location and orientation of the device; and
updating rendered elements in the augmented view based on a change in device location, a change in the orientation of the device, and/or a change in the weather data over time.

2. The computer-implemented method of claim 1, wherein the augmented view of weather conditions is rendered on a display of the device using a front facing camera of the device.

3. The computer-implemented method of claim 1, wherein the augmented view of weather conditions includes a set of tokens indicating characteristics of the weather conditions.

4. The computer-implemented method of claim 3, wherein the set of tokens includes a token corresponding to a type of weather condition.

5. The computer-implemented method of claim 3, wherein the set of tokens includes a token corresponding to a distance of a weather condition.

6. The computer-implemented method of claim 3, wherein the set of tokens includes a token corresponding to a time of impact of a weather condition.

7. The computer-implemented method of claim 3, wherein the set of tokens includes a token corresponding to a severity of a weather condition.

8. The computer-implemented method of claim 1, wherein the particular point in time is selected by the user of the device.

9. The computer-implemented method of claim 1, wherein the weather data is received from a spatial weather translation system, wherein weather data and observed weather phenomena are transformed from 2D plotting and/or radar data to data elements that are consumable by an interface system that performs the rendering on the device of the user.

10. The computer-implemented method of claim 1, wherein the weather conditions are selected from the group consisting of: precipitation, precipitation intensity, direction of wind, direction of movement of a storm front, distance to precipitation in the augmented view, lightning strikes as said strikes occur, and depth of precipitation accumulation.

11. The computer-implemented method of claim 1, further comprising:
displaying, on the device of the user, a time-selection user interface element allowing the user to select a time for which corresponding weather conditions will be displayed;
receiving, from the user of the device, a selection of a particular time to display weather conditions on the time-selection user interface element; and
rendering, on the device of the user, a second augmented view of weather conditions corresponding to the selection of the particular time by the user.

12. A computer program product, the computer program product comprising:
one or more computer readable storage media, and program instructions collectively stored on the one or more computer readable storage media, the program instructions comprising:
program instructions to receive a set of weather data corresponding to a region, the set of weather data indicating current and/or future weather conditions based on time;
program instructions to determine a location and an orientation of a device of a user; and
program instructions to render, on the device of the user, an augmented view of weather conditions at a particular point in time based on the set of weather data and the determined location and orientation of the device; and
program instructions to update rendered elements in the augmented view based on a change in device location, a change in the orientation of the device, and/or a change in the weather data over time.

13. The computer program product of claim 12, wherein the augmented view of weather conditions is rendered on a display of the device using a front facing camera of the device.

14. The computer program product of claim 12, wherein the augmented view of weather conditions includes a set of tokens indicating characteristics of the weather conditions.

15. The computer program product of claim 14, wherein the set of tokens includes a token corresponding to a type of weather condition, a token corresponding to a distance of a weather condition, a token corresponding to a time of impact of a weather condition, and a token corresponding to a severity of a weather condition.

16. The computer program product of claim 12, wherein the particular point in time is selected by the user of the device.

17. The computer program product of claim 12, wherein the weather data is received from a spatial weather translation system, wherein weather data and observed weather phenomena are transformed from 2D plotting and/or radar data to data elements that are consumable by an interface system that performs the rendering on the device of the user.

18. The computer program product of claim 12, wherein the weather conditions are selected from the group consisting of: precipitation, precipitation intensity, direction of wind, direction of movement of a storm front, distance to precipitation in the augmented view, lightning strikes as said strikes occur, and depth of precipitation accumulation.

19. The computer program product of claim 12, further comprising:
program instructions to display, on the device of the user, a time-selection user interface element allowing the user to select a time for which corresponding weather conditions will be displayed;
program instructions to receive, from the user of the device, a selection of a particular time to display weather conditions on the time-selection user interface element; and
program instructions to render, on the device of the user, a second augmented view of weather conditions corresponding to the selection of the particular time by the user.

20. A system, comprising:
a processor; and
logic integrated with the processor, executable by the processor, or integrated with and executable by the processor, the logic being configured to:
receive a set of weather data corresponding to a region, the set of weather data indicating current and/or future weather conditions based on time;
determine a location and an orientation of a device of a user, and
render, on the device of the user, an augmented view of weather conditions at a particular point in time based on the set of weather data and the determined location and orientation of the device; and
update rendered elements in the augmented view based on a change in device location, a change in the orientation of the device, and/or a change in the weather data over time.
